(19) United States
(12) Patent Application Publication
(10) Pub. No.: US 2025/0207441 A1
(43) Pub. Date: Jun. 26, 2025

(54) DEVICE FOR HOLDING A SLIDING DOOR ARRANGEMENT WITH AN EXTERIOR SLIDING FOR A MOTOR VEHICLE

(71) Applicant: RENAULT SAS, BOULOGNE BILLANCOURT (FR)

(72) Inventors: Philippe GAILLARD, LE CHESNAY (FR); Bérénice RAPIOR, Villiers Saint Frédéric (FR)

(21) Appl. No.: 18/991,096

(22) Filed: Dec. 20, 2024

(30) Foreign Application Priority Data
Dec. 21, 2023 (FR) 2314945

(51) Int. Cl. E05C 17/62

(52) U.S. Cl. CPC E05C 17/62; E05Y 2900/531

(57) ABSTRACT

A retaining device for an external pocket sliding door arrangement for a motor vehicle, the arrangement comprising at least one external pocket sliding door moveable between a closed position in which the sliding door closes off access to the interior of a passenger compartment and/or a loading area of the vehicle, and an open position in which the sliding door leaves access to the interior of the passenger compartment and/or the loading area of the vehicle free, the retaining device being characterised in that it is configured to keep the sliding door in its closed position, in particular in the event of an impact exerted laterally against the sliding door, the retaining device being characterised in that it is further configured to cooperate with a door check system of the arrangement when the sliding door is in its open position, to keep the sliding door in its open position.

The present patent application claims the benefit of document FR2314945 filed on Dec. 21, 2023, which is incorporated by reference herein.

The invention relates to a retaining device for an external pocket sliding door arrangement for a motor vehicle. The invention further relates to a motor vehicle comprising such a retaining device for such an external pocket sliding door arrangement.

Some motor vehicles are fitted with sliding doors that allow access to the passenger compartment and/or boot of the vehicle to be blocked or opened. For each sliding door, a retaining device, commonly known as an “impact retaining pin”, is generally fixed to the body of the motor vehicle, for example at the pillar B. Such an “impact retaining pin” is described, for example, in patent application DE 10 2007 051 718 A1.

A retaining device is used to keep the sliding door in its closed position, thus preventing the sliding door from opening in the event of a forced transverse movement of said door towards the outside. A retaining device known from the prior art generally takes the form of a male part carried by the body of the motor vehicle. This male part is then configured to be inserted into a female housing such as a hole formed in the body of the sliding side door.

Thus, in the event of a forced transverse movement of the sliding door towards the outside, which may occur when the motor vehicle rolls after going off-road; for example, the retaining device comes into abutment in the housing formed in the body of the sliding side door so as to prevent the door from opening outwards.

The sliding door is also usually held in the open position by a door check. Various types of door check are known in the state of the art, such as “hard point” doorstops or “positive” doorstops. A door check of the “hard point” type is, for example, described in document EP1775404A1. A door check of the “positive” type is, for example, described in documents FR2541716 and EP1780354.

These door checks are mechanisms independent of the “impact retaining pin” known from the prior art described earlier in this introduction. The door checks are configured to keep a sliding door in the open position in order to prevent said sliding door from accidentally closing, which can happen under the effect of gravity, for example when the motor vehicle equipped with such sliding doors is stationary on a sloping, inclined surface.

Thus, according to the solutions known in the current prior art, the sliding door is held in its closed position by an impact retaining pin, while the sliding door is held in its open position by a door check which is separate from the impact retaining pin. In other words, the two functions of keeping the door in one position or the other are carried out by two separate and independent mechanisms.

The aim of the invention is to offer an alternative to these two distinct mechanisms.

To this end, the invention relates to a retaining device for an external pocket sliding door arrangement for a vehicle, in particular a motor vehicle, said arrangement comprising at least one external pocket sliding door configured to be moved between a closed position in which the sliding door closes off access to the interior of a passenger compartment and/or a loading area of the vehicle, and an open position in which the sliding door leaves access to the interior of said passenger compartment and/or said loading area of the vehicle free, the retaining device being characterised in that it is configured to keep said sliding door in its closed position, in particular in the event of an impact exerted laterally against the sliding door, the retaining device being characterised in that it is further configured to cooperate with a door check system of the arrangement when said sliding door is in its open position, so as to keep said sliding door in its open position.

In one embodiment, the retaining device comprises a protruding rod with a hook-shaped free end configured to keep said sliding door in its closed position.

In one embodiment, the retaining device has a connecting block between the protruding rod and the hook-shaped free end.

In one embodiment, the protruding rod and/or its free end has a marked area on the surface of said rod, and said marked area is configured to allow assessment of the state of wear of the retaining device.

In one embodiment, the protruding rod has a polygonal or rounded cross-section.

In one embodiment, the retaining device comprises a single one-piece component.

In one embodiment, the retaining device comprises a metallic material.

The invention further relates to an external pocket sliding door arrangement for a motor vehicle, characterised in that it comprises a retaining device as described above and characterised in that said retaining device projects from a pillar of a body of a motor vehicle so that it cooperates with a housing provided in the sliding door so as to keep said sliding door in its closed position.

According to one embodiment, the arrangement further comprises a door check system comprising a resilient return member, said door check system is configured to cooperate with said retaining device.

In one embodiment, the door check system further comprises a movement member, and said movement member is configured to cooperate with the retaining device.

The invention also relates to a motor vehicle characterised in that it is equipped with a retaining device as described above or equipped with a pocket sliding door arrangement as described above.

These objects, features and advantages of the present invention will be set out in detail in the following description of a particular embodiment made by way of non-limitation in relation to the attached figures among which:

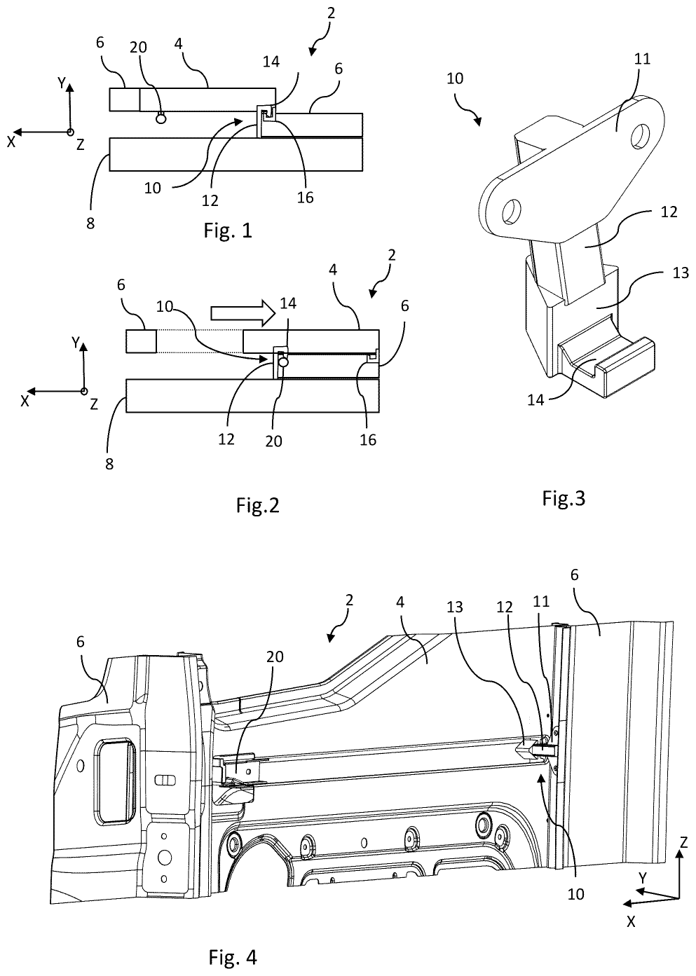

FIG. 1 schematically illustrates a cross-sectional view of an external pocket sliding door arrangement which comprises a retaining device according to the invention.

FIG. 2 schematically illustrates another cross-sectional view of an external pocket sliding door arrangement which comprises a retaining device according to the invention.

FIG. 3 is a perspective view of the retaining device according to the invention.

FIG. 4 is a perspective view of an external pocket sliding door arrangement in a closed configuration, incorporating the retaining device of FIG. 3.

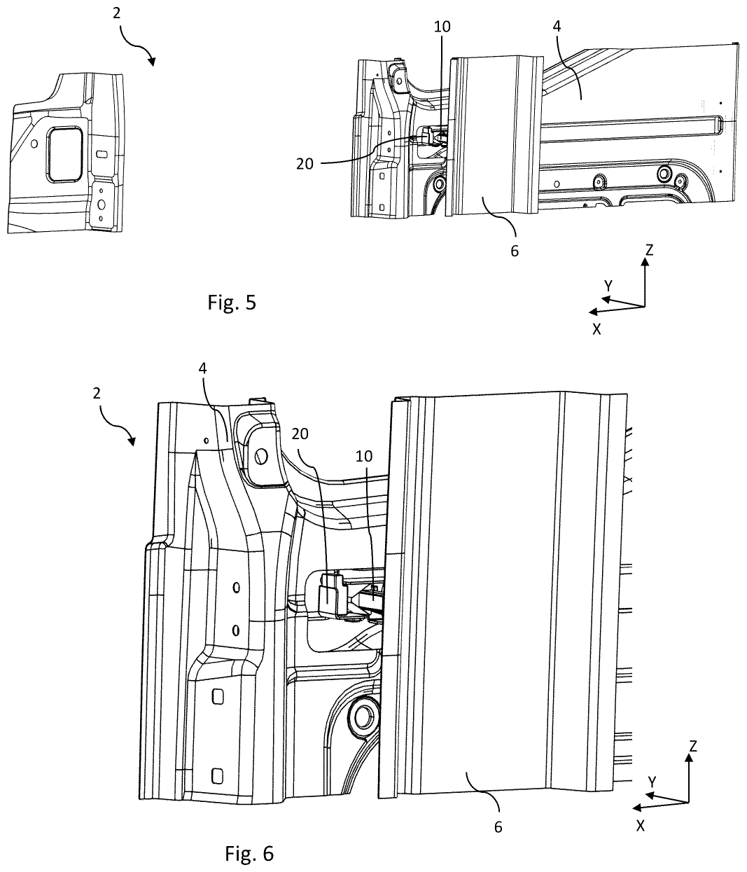

FIG. 5 is a perspective view of an external pocket sliding door arrangement in an open configuration, incorporating the retaining device of FIG. 3.

FIG. 6 is a detailed view of FIG. 5.

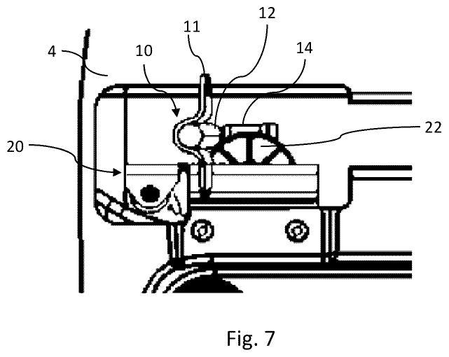

FIG. 7 is a detailed view of an external pocket sliding door arrangement in an open configuration with a different type of check system.

A trihedron with three axes X, Y, Z is illustrated in some of the figures. In this document, the X axis refers to the longitudinal axis of the motor vehicle. When moving forwards in a straight line, the vehicle moves from rear to front in a direction parallel to its longitudinal axis. The X axis is oriented 15 from the front to the rear of the vehicle, i.e. in the direction of reverse travel. The Y axis is the vehicle's transverse axis. The Z axis is the axis perpendicular to the X and Y axes. The vehicle is assumed to be resting on level ground. The Z axis is a vertical axis, oriented from bottom to top. The X, Y and Z axes form an orthogonal reference frame.

There are a plurality of types of arrangements 2 for sliding doors 4 for motor vehicles. Generally speaking, a distinction is made, for example, between so-called “conventional” sliding doors and so-called “pocket” sliding doors 4.

A sliding door on a motor vehicle is said to be “conventional” when moving the sliding door from its closed position to its open position or vice versa involves moving the door sideways towards the outside of the vehicle. In other words, in a “conventional” sliding door arrangement, the movement 30 of said sliding door is not a rectilinear translation along one and the same axis of movement, but rather a movement along two directions perpendicular to one another, in particular along the lateral direction Y and along the longitudinal direction X.

A sliding door 4 on a motor vehicle is termed “pocket” when the sliding door 4 is not moved laterally outwards during its movement between its open position and its closed position. In other words, in a pocket sliding door 4 arrangement 2 for a motor vehicle, the sliding door 4 can be moved in a straight line between its open position and its closed position in a single direction, parallel to the axis X of the motor vehicle.

A distinction is also made between two sub-categories of arrangements 2 for sliding doors 4, namely internal pocket sliding doors 4 and external pocket sliding doors 4.

In the case of internal pocket sliding doors 4, the sliding door 4 slides along the inside of a body 6 of the motor vehicle. Thus, when the sliding door 4 is in its open position, said sliding door 4 is located between a body pillar of the motor vehicle and the interior of the passenger compartment 8 of said motor vehicle.

In the case of external pocket sliding doors 4, the sliding door 4 slides along the outside of the body 6 of the motor vehicle. In this way, said sliding door 4 is located on the exterior, outside the passenger compartment 8 of said motor vehicle in both its open and closed positions.

In such an external pocket sliding door 4 arrangement 2, it is possible to design a retaining device 10 which not only makes it possible to keep the sliding door 4 in its closed position, particularly in the event of an impact exerted laterally against the sliding door 4, but which is also configured to cooperate with a door check system 20 when the said sliding door 4 is in its open position, so as to keep said sliding door 4 in its open position.

FIGS. 1 and 2 schematically illustrate cross-sectional views of an external pocket sliding door 4 arrangement 2 for a motor vehicle which comprises such a retaining device 10.

FIG. 1 shows the sliding door 4 in its closed position. In this closed position, the sliding door 4 blocks access to the interior of a passenger compartment 8 and/or a motor vehicle boot.

FIG. 2 shows the sliding door 4 in its open position. In this open position, the sliding door 4 enables access to the interior of a passenger compartment 8 and/or a motor vehicle boot. An arrow indicates the direction of movement followed by the sliding door 4 when it is moved from its closed position to its open position.

In any conceivable embodiment of the retaining device 10, it comprises a protruding rod 12 with a free end 14 that is hook-shaped, configured to keep said door in its closed position.

In the embodiment illustrated in FIG. 1, the retaining device 10 comprises a protruding rod 12 carried by one side of the body 6 of the motor vehicle. More specifically, the protruding rod 12 projects from a pillar B of said body 6 of the motor vehicle. The protruding rod 12 has a free end 14 which is hook-shaped. This hook-shaped free end 14 is configured to keep the sliding door 4 in its closed position, particularly in the event of an impact exerted laterally against said sliding door 4. In the specific embodiment illustrated in FIG. 1, the hook-shaped free end 14 cooperates with a housing 16 provided in the sliding door 4 so as to keep said door 4 in its closed position.

A specific embodiment of the retaining device 10 is more particularly shown in FIG. 3. In this particular embodiment, the retaining device 10 comprises a single one-piece part, making it more robust. In this embodiment, the protruding rod 12 has a substantially square cross-section. More generally, the protruding rod 12 may have a polygonal cross-section. At the junction between the protruding rod 12 and its hook-shaped free end 14, a connecting block 13 in the form of a triangular prism may be present. The connecting block 13 can be used to reinforce the connection between the protruding rod 12 and its hook-shaped free end 14.

Another end of the protruding rod 12, the end that is not connected to the hook-shaped free end 14, may have a retention plate 11 that enables the retaining device 10 to be fixed to a support. The retention plate 11 can have at least one opening, such as a circular hole, to allow a retention element, such as a screw, to pass through. In the embodiment shown in FIG. 3, the retention plate 11 has two circular holes, for example.

According to a particular non-illustrated embodiment of the retaining device 10, the protruding rod 12 and/or its free end 14 has a marked area on its surface. Said marked area is configured in such a case to allow assessment of the state of wear of the retaining device 10. The marked area may take the form of a coloured area on the surface of the protruding rod 12 and/or its free end 14, the colour of which varies according to the state of wear of the retaining device 10.

Alternatively, the marked area may take the form of an area on the surface of the protruding rod 12 and/or its free end 14 with a particular ribbed pattern and/or roughness, the appearance and roughness of which changes according to the state of wear of the retaining device 10.

FIGS. 4, 5 and 6 illustrate perspective views of an external pocket sliding door 4 arrangement 2 for a motor vehicle which comprises the retaining device 10 as described above.

In any conceivable embodiment of the retaining device 10, it is also configured to cooperate with a door check system 20 when said sliding door 4 is in its open position, so as to keep said sliding door 4 in its open position.

Thus, in the embodiment illustrated in FIG. 2, the protruding rod 12 carried by the body 6 of the motor vehicle and/or its hook-shaped free end 14 cooperates with the door check system 20 when the sliding door is in its open position, so as to keep said door in its open position.

In this way, the retaining device 10 makes it possible on the one hand to keep the sliding door 4 in its closed position, and on the other hand to participate with the door check system 20 in keeping the sliding door 4 in its open position.

FIG. 4 shows the sliding door 4 in its closed position. In this closed position, the sliding door 4 blocks access to the interior of a passenger compartment 8 and/or to the interior of a motor vehicle boot. The retaining device 10 is attached to a pillar of the body 6 of the motor vehicle fitted with said arrangement 2.

In FIGS. 5 and 6, the sliding door 4 is shown in its open position. In this open position, the sliding door 4 enables access to the interior of a passenger compartment 8 and/or to the interior of a motor vehicle boot. When the sliding door 4 adopts this open position, the retaining device 10 cooperates with the door check system 20, so as to keep said door in its open position. This is shown in greater detail in FIG. 6.

If the door check system 20 is of the “positive” type, it comprises, for example, a pivoting lever with a hook-shaped free end. When the sliding door 4 adopts its open position, the hook at the free end of the pivoting lever of the “positive”-type door check is engaged around the protruding rod 12 of the retaining device 10 so as to keep the sliding door 4 in its open position.

If the door check system 20 is of the “hard point” type, it comprises, for example, a resilient return member, such as a spring or leaf spring, and, optionally, a movement member 22, which may be in the form of a roller or in the form of a slide, or even in the form of a runner.

In the case where the door check system 20 comprises a resilient return member in the form of a leaf spring, as in the embodiment illustrated in FIGS. 4, 5 and 6, said leaf spring is caused to strike the protruding rod 12 of the retaining device 10 when the sliding door 4 is moved from its closed position to its open position, and to be deformed under the effect of this impact. The leaf spring generally returns to its nominal position after impact, when the sliding door 4 is in its open position. In this way, the leaf spring is retained by the protruding rod 12 of the retaining device and/or its hook-shaped free end 14, so as to keep said sliding door 4 in its open position.

In the case where the door check system 20 comprises a resilient return member in the form of a spring and a movement member 22, such as a roller or a slide or a runner, said movement member 22 is caused to strike the protruding rod 12 of the retaining device 10 when the sliding door 4 is moved from its closed position to its open position. The resilient return member is then caused to deform under the impact, so as to follow the movement of the movement member 22, which is then caused to be housed behind the protruding rod 12 of the retaining device 10, or in the hollow of its hook-shaped free end 14. In other words, the movement member 22 of the door check system 20 is kept in a blocking position by the retaining device 10, which enables the sliding door 4 to be kept in its open position. Such a position of blocking the movement member 22 of the door check system 20 by the retaining device 10 is illustrated in particular in FIG. 7.

In a particular embodiment of the retaining device 10, the protruding rod 12 may have a rounded cross-section, as illustrated in particular in FIG. 7. More specifically, the protruding rod 12 may be cylindrical or conical in shape. Such a shape of the protruding rod 12 of the retaining device 10 may allow a less abrupt, i.e. more gradual deformation of the resilient return member and/or facilitate the passage of the movement member 22 on said protruding rod 12, which may contribute to the durability of the mechanism.

In one example, the retaining device 10 comprises a metallic material. This metallic material may, for example, include aluminium. In particular, the retaining device 10 can be manufactured using a moulding process.

In such an external pocket sliding door 4 arrangement 2, it is thus possible to design a retaining device 10 which not only makes it possible to keep the sliding door 4 in its closed position, particularly in the event of an impact exerted laterally against the sliding door 4, but which is also configured to cooperate with a door check system 20 when the said sliding door 4 is in its open position, so as to keep said sliding door 4 in its open position.

1. A retaining device for an external pocket sliding door arrangement for a vehicle, said arrangement comprising at least one external pocket sliding door configured to be moved between a closed position in which the sliding door closes off access to the interior of a passenger compartment and/or a loading area of the vehicle, and an open position in which the sliding door leaves access to the interior of said passenger compartment and/or said loading area of the vehicle free, wherein the retaining device is configured to keep the said sliding door in its closed position, wherein the retaining device is further configured to cooperate with a door check system of the arrangement when said sliding door is in its open position, so as to keep said sliding door in its open position.

2. The retaining device according to claim 1, wherein the retaining device comprises a protruding rod with a hook-shaped free end configured to keep said sliding door in its closed position.

3. The retaining device according to claim 2, wherein the retaining device has a connecting block between the protruding rod and the hook-shaped free end.

4. The retaining device according to claim 2, wherein the protruding rod and/or its free end has a marked area on the surface of said rod, and in that said marked area is configured to allow assessment of the state of wear of the retaining device.

5. The retaining device according to claim 2, wherein the protruding rod has a polygonal or rounded cross-section.

6. The retaining device according to claim 1, wherein it comprises a single one-piece part.

7. The retaining device according to claim 1, wherein it comprises a metallic material.

8. An arrangement of an external pocket sliding door for a motor vehicle, wherein the arrangement comprises a retaining device according to claim 1 and wherein said retaining device projects from a pillar of a body of a motor vehicle so that it cooperates with a housing provided in the sliding door so as to hold said sliding door in its closed position.

9. The arrangement of an external pocket sliding door according to claim 8, wherein the arrangement further comprises a door check system comprising a resilient return member, and wherein said door check system is configured to cooperate with said retaining device.

10. The arrangement of an external pocket sliding door according to claim 8, wherein the door check system further comprises a movement member, and wherein said movement member is configured to cooperate with said retaining device.

11. A motor vehicle, wherein the motor vehicle is equipped with the retaining device according to claim 1.

12. A motor vehicle, wherein the motor vehicle is equipped with the pocket sliding door arrangement according to claim 8.
